(19) United States
(12) Patent Application Publication
(10) Pub. No.: US 2026/0301450 A1
(43) Pub. Date: Oct. 1, 2026

(54) INFORMATION MANAGEMENT APPARATUS AND INFORMATION PROCESSING SYSTEM

(71) Applicant: Honda Motor Co., Ltd., Tokyo (JP)

(72) Inventors: Tokitomo Ariyoshi, Saitama (JP); Umiaki Matsubara, Saitama (JP); Mayu Watanabe, Saitama (JP); Yutaka Nishizaki, Tokyo (JP); Meika Sugimoto, Tokyo (JP); Taisei Ito, Tokyo (JP); Miki Kawabuchi, Tokyo (JP); Ryosuke Kasuga, Tokyo (JP)

(21) Appl. No.: 19/631,008

(22) Filed: Mar. 27, 2026

(30) Foreign Application Priority Data
Mar. 31, 2025 (JP) 2025-057739

(51) Int. Cl. G06V 20/70; G06T 1/60; G06V 10/764

(52) U.S. Cl. CPC G06V 20/70; G06T 1/60; G06V 10/764

(57) ABSTRACT

An information management apparatus includes: a microprocessor and a memory connected to the microprocessor. The microprocessor is configured to execute task management assigning to a worker a task of adding annotation information to an object in an image, the memory stores a target image, the target image being an image to which the annotation information is to be added by the worker, and the microprocessor is further configured to perform: setting the task so as to add the annotation information to one object included in the target image, and in the task management, storing information of the task in the memory in association with the target image.

### CROSS-REFERENCE TO RELATED APPLICATION

This application is based upon and claims the benefit of priority from Japanese Patent Application No. 2025-057739 filed on Mar. 31, 2025, the content of which is incorporated herein by reference.

### BACKGROUND

### Technical Field

The present invention relates to an information management apparatus and an information processing system for processing information relating to an annotation.

### Related Art

Conventionally, devices designed to support annotation work for creating training data for machine learning models is known (see, e.g., JP 2002-87184 A). In the device described in JP 2002-87184 A, when distributing images to be worked on to annotators who are the workers, images are allocated based on the annotation accuracy of the annotators.

However, simply distributing images based on the work accuracy of annotators, as in the device described in JP 2002-87184 A, cannot sufficiently support annotation work.

### SUMMARY

An aspect of the present invention is an information management apparatus including: a microprocessor and a memory connected to the microprocessor. The microprocessor is configured to execute task management assigning to a worker a task of adding annotation information to an object in an image, the memory stores a target image, the target image being an image to which the annotation information is to be added by the worker, and the microprocessor is further configured to perform: setting the task so as to add the annotation information to one object included in the target image, and in the task management, storing information of the task in the memory in association with the target image.

Another aspect of the present invention is an information management apparatus including: a microprocessor and a memory connected to the microprocessor. The microprocessor is configured to perform task management assigning to a worker a task of adding annotation information to an object in an image, the memory stores a target image, the target image being an image to which the annotation information is to be added by the worker, and the microprocessor is further configured to perform: setting the task so as to add the annotation information to a predetermined number of objects included in the target image, and in the task management, storing information of the task in the memory in association with the target image.

### BRIEF DESCRIPTION OF THE DRAWINGS

The objects, features, and advantages of the present invention will become clearer from the following description of embodiments in relation to the attached drawings, in which:

FIG. 1 is a block diagram schematically illustrating an overall configuration of an information processing system including an information management apparatus according to an embodiment of the present invention;

FIG. 2 is a block diagram illustrating a main configuration of the management apparatus of FIG. 1;

FIG. 3A is a diagram illustrating data recorded in an image database;

FIG. 3B is a diagram illustrating data recorded in an annotator database;

FIG. 4 is a block diagram illustrating a main configuration of the annotator terminal of FIG. 1;

FIG. 5 is a flowchart illustrating an example of processing executed by the controller of FIG. 2;

FIG. 6 is a flowchart illustrating an example of processing in step S106 of FIG. 5;

FIG. 7 is a flowchart illustrating an example of processing in step S107 of FIG. 5;

FIG. 8 is a flowchart illustrating an example of processing executed by the controller of FIG. 4;

FIG. 9 is a diagram illustrating an example of a target image including a vehicle;

FIG. 10A is a diagram illustrating an example of a target image displayed on the display device of FIG. 4;

FIG. 10B is a diagram illustrating another example of a target image displayed on the display device of FIG. 4;

FIG. 10C is a diagram illustrating another example of a target image displayed on the display device of FIG. 4;

FIG. 11 is a block diagram schematically illustrating another example of the overall configuration of the information processing system;

FIG. 12 is a block diagram illustrating a main configuration of the information processing apparatus of FIG. 11; and

FIG. 13 is a diagram for explaining an annotation operation.

### DETAILED DESCRIPTION

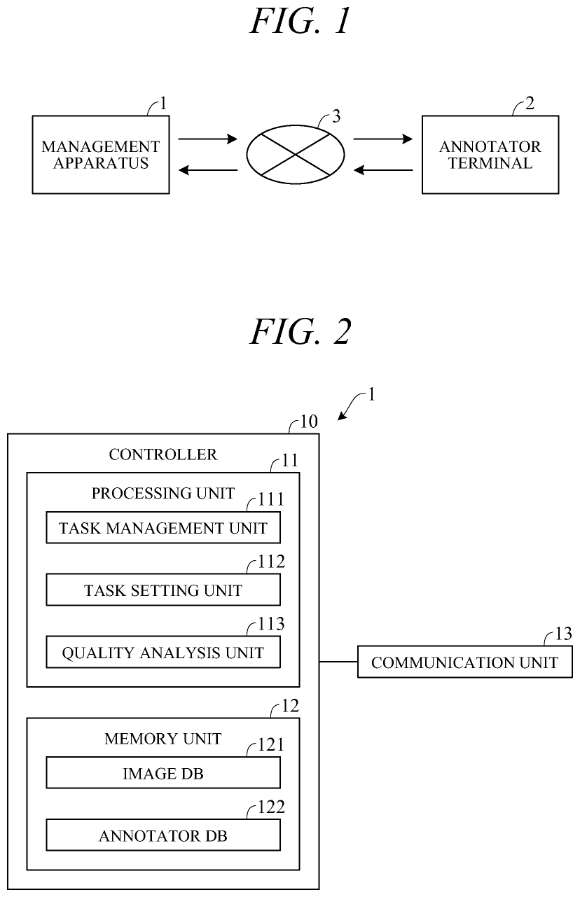

Hereinafter, embodiments of the invention will be described with reference to the drawings. An information management apparatus (hereinafter simply referred to as a management apparatus) according to an embodiment of the present invention is a device for supporting annotation work of an annotator. FIG. 1 is a block diagram schematically illustrating an example of an overall configuration of an information processing system 100 including a management apparatus 1 according to the present embodiment. As illustrated in FIG. 1, the information processing system 100 includes a management apparatus 1 and a communication terminal (hereinafter referred to as an annotator terminal) 2 used by the annotator.

The management apparatus 1 and the annotator terminal 2 are communicably connected by a communication network 3. The communication network 3 includes not only a public wireless communication network represented by the Internet network, a mobile telephone network, or the like but also a closed communication network provided for every predetermined management region, for example, a wireless LAN, Wi-Fi (registered trademark), Bluetooth (registered trademark), or the like.

The annotator terminal 2 is a communication terminal such as a tablet terminal. Although FIG. 1 illustrates one annotator terminal 2, a plurality of annotator terminals 2 may be connected to the management apparatus 1 via the communication network 3.

FIG. 2 is a block diagram illustrating a configuration of a main part of the management apparatus 1 of FIG. 1. The management apparatus 1 includes a controller 10 and a communication unit 13.

The communication unit 13 is a communication interface that connects the management apparatus 1 to the communication network 3. The management apparatus 1 transmits and receives information to and from the annotator terminal 2 and the like connected to the communication network 3 via the communication unit 13.

The controller 10 includes a computer including a processing unit 11 such as a microprocessor (CPU), a memory unit 12 such as a ROM and a RAM, and other peripheral circuits (not illustrated) such as an I/O interface. The processing unit 11 functions as a task management unit 111, a task setting unit 112, and a quality analysis unit 113 by executing a program stored in the memory unit 12.

The memory unit 12 includes an image database (DB) 121 and an annotator DB 122. The image DB 121 stores image data (hereinafter referred to as target image data or simply a target image) serving as an annotation target and image data (hereinafter referred to as the processed image data or simply the processed image) for which an annotation has been already executed.

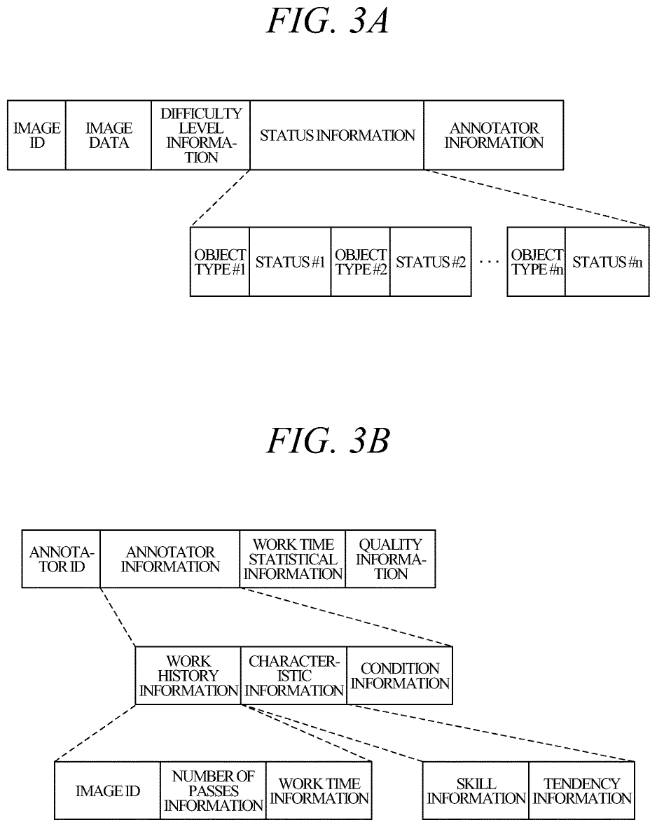

The target images are classified into groups based on at least one of an imaging environment, a feature (brightness etc.) of an image, and a type of an object in the image and stored in the image DB 121. The processed image is an image that does not require an additional annotation and can be used as learning data of a machine learning model. The image DB 121 stores image data representing an image, status information, difficulty level information, and added annotation information in association with an image ID for each image (target image and processed image). FIG. 3A is a diagram illustrating data recorded in the image DB 121.

The status information is information indicating whether or not the addition of the annotation information with respect to the image has been completed, that is, whether or not the annotation information has been added to all the objects to be annotated included in the image. In a case where objects of different types from each other are included in the image, status information for each type of object is stored in association with the image ID of each target image as illustrated in FIG. 3A. The difficulty level information is information indicating the difficulty level of the annotation with respect to the image.

The annotator DB 122 stores information regarding the annotator (hereinafter referred to as annotator information). The annotator DB 122 further stores work time statistical information and quality information to be described later. FIG. 3B is a diagram illustrating data recorded in the annotator DB 122.

As illustrated in FIG. 3B, the annotator information includes work history information indicating a work history of the annotator and characteristic information indicating a work characteristic of the annotator in association with identification information (hereinafter referred to as an annotator ID) of the annotator. The annotator information further includes condition information indicating a condition (such as physical condition and concentration) of the annotator.

As illustrated in FIG. 3B, the work history information includes identification information (hereinafter referred to as an image ID) of each target image on which the annotation has been executed by the annotator. The work history information includes number of passes information indicating the number of times the annotator has performed the pass operation on each target image, and work time information indicating the work time of the annotator for each target image. The pass operation will be described later.

As illustrated in FIG. 3B, the characteristic information includes skill information indicating the level of the work skill of the annotator and tendency information indicating the work target (image) that the annotator is not good at. The image that the annotator is not good at is an image in which the number of times of execution of the pass operation is equal to or greater than a predetermined number or an image in which the annotation accuracy is low. The tendency information includes an image ID of an image of which the number of times of execution of the pass operation is equal to or greater than a predetermined number among the images set as the work target of the annotator or an image group to which the image belongs, and an image ID of an image in which the annotation accuracy is equal to or less than a predetermined degree. The tendency information may also include a work target (image) that the annotator is good at. The image that the annotator is good at is, for example, an image with short annotation work or an image with high annotation accuracy.

The task management unit 111 manages a task assigned to the annotator. The task is a work of adding annotation information to an object in an image. The annotation information includes segmentation information in which a boundary of an object is represented by a polygon, and labeling information indicating a type (vehicle, pedestrian, traffic sign, signal, etc.) of the object.

The task management unit 111 detects a change in the work time of the annotator based on the work time statistical information stored in the annotator DB 122. The task management unit 111 detects a change in the work quality of the annotator based on the quality information stored in the annotator DB 122. Furthermore, the task management unit 111 generates condition information based on the detected change in work time or change in work quality, and stores the condition information in the annotator DB 122.

Upon receiving a login request (authentication request) to be described later from the annotator terminal 2, the task management unit 111 reads the target image to be transmitted to the annotator terminal 2 from the image DB 121 based on the annotator ID accompanying the login request. Specifically, the task management unit 111 first acquires, from the annotator DB 122, the annotator information stored in association with the annotator ID of the annotator, more specifically, the characteristic information.

The task management unit 111 determines a task (work content) to be assigned to the annotator based on the annotator information stored in the annotator DB 122, more specifically, the characteristic information.

The task management unit 111 recognizes the level of the annotation skill of the annotator based on the skill information included in the characteristic information. The task management unit 111 reads, from the image DB 121, a series of target images (e.g., 25 images) of which the difficulty level of the annotation corresponds to the level of the annotation skill of the annotator based on the difficulty level information stored in the image DB 121. Thus, a target image of a difficulty level suitable for the level of annotation skill can be assigned to the annotator.

At this time, the task management unit 111 extracts a series of target images from the image DB 121 based on the tendency information included in the characteristic information such that the image that the annotator is not good at is excluded. As a result, it is possible to suppress an image that the annotator is not good at from being assigned to the annotator as the target image.

Note that the task management unit 111 may classify the target image based on an imaging environment (highway etc.) in which the image is acquired, a feature (e.g., brightness (luminance)) of the image, and a type of an object (e.g., vehicle) included in the image, and extract target images of the same classification as a series of target images. In this way, the work efficiency of the annotator can be improved by assigning the target images of the same classification to the annotator.

Note that, in a case where the target image is classified based on the type of the object, the task management unit 111 applies provisional segmentation serving as preprocessing to each target image stored in the image DB 121 in advance, and recognizes the type of the object included in each target image. The provisional segmentation is, for example, semantic segmentation.

The task management unit 111 transmits the series of target images read from the image DB 121 to the annotator terminal 2 via the communication unit 13. In this way, the task is assigned to the annotator. At this time, the task management unit 111 transmits window setting information and mask setting information to be described later together with the series of target images.

The task setting unit 112 sets the task to be assigned to the annotator such that the annotation for one target image is executed on one object in the image. Specifically, the task setting unit 112 sets a window (hereinafter referred to as a work window) indicating an addition target region of the annotation information with respect to the target image. More specifically, the task setting unit 112 generates information (hereinafter referred to as window setting information) designating the shape, size, transparency, and scanning method of the work window. It is assumed that the work window has a rectangular shape.

The task setting unit 112 preferentially applies a window having a small size to the work window from among a plurality of windows having different sizes prepared in advance. Note that the annotator may be able to designate a size to be applied to the work window from among a plurality of windows having different sizes. Furthermore, the task setting unit 112 may set the size of the work window based on the size of the object assumed to exist in the target image.

For example, in a case where the target image is an imaged image acquired by an in-vehicle camera of a vehicle traveling on a highway, that is, in a case where the imaging environment of the target image is a highway, it is assumed that a vehicle exists in the image. Therefore, in that case, the task setting unit 112 sets the size of the work window based on the maximum sizes in the longitudinal direction and the lateral direction of the vehicle (the front vehicle or the oncoming vehicle) estimated within the angle of view of the in-vehicle camera.

In addition, the task setting unit 112 may obtain a typical size of the work window and apply the obtained size to the work window to be superimposed and displayed on the target image. The typical size of the work window may be obtained by performing data processing on the processed image stored in the image DB 121 and calculating the distribution of the shape and size of the bounding box applied to the object in the image, or may be obtained by other methods.

Furthermore, the task setting unit 112 may classify the processed images stored in the image DB 121 for each type of object to which the annotation information is added, and apply the size and shape most frequently applied to the processed images classified into the same group to the work window.

In addition, the task setting unit 112 sets an allowable error of the annotation. The number of pixels (hereinafter referred to as the number of constituent pixels) constituting the region corresponding to the object decreases as the object (object having a longer distance from the image viewpoint) is deeper in the image. If the number of constituent pixels is small, the contour and fine features of the object are not sufficiently expressed, and accurate segmentation becomes difficult. Therefore, the task setting unit 112 sets the allowable error of the annotation to be larger and sets the annotation accuracy to be obtained by the annotator to be lower for an object having a smaller number of constituent pixels. The annotation accuracy includes segmentation accuracy evaluated by a protruding amount of segmentation or a size of a margin, and labeling accuracy evaluated by a labeling error or a labeling omission.

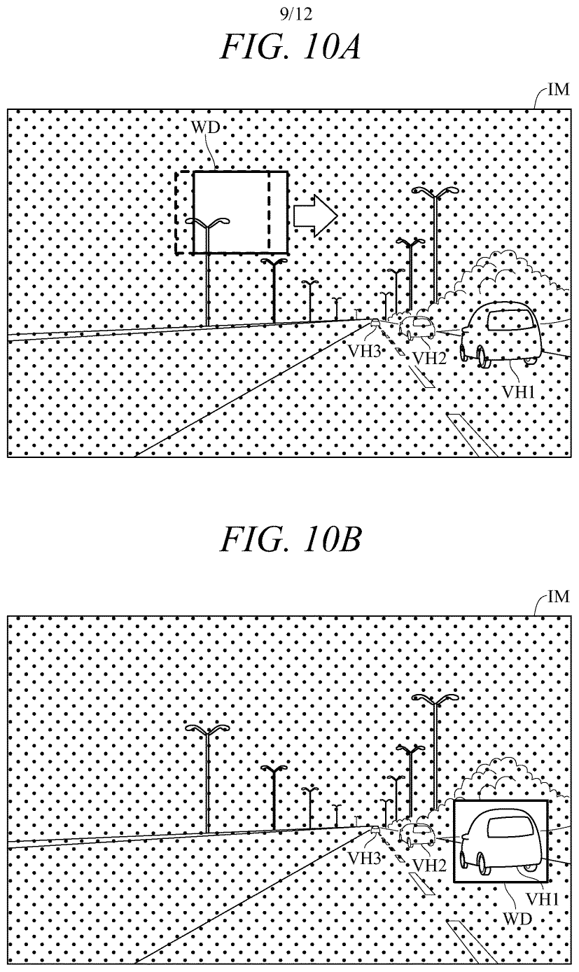

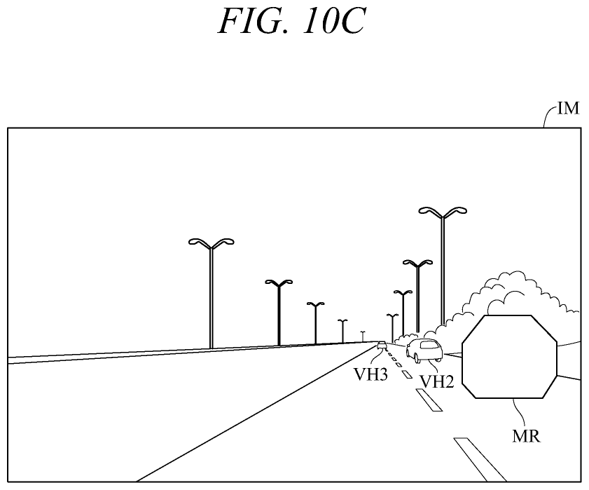

In addition, the task setting unit 112 sets a mask (FIG. 10C to be described later) in the target image such that the region of the object to which the annotation information has already been attached cannot be visually recognized. More specifically, the task setting unit 112 generates information (hereinafter referred to as mask setting information) designating the shape, size, and display position of the mask corresponding to the object based on the annotation information attached to the object in the target image.

In addition, the task setting unit 112 sets a next or subsequent task of the annotator such that the target image whose annotation has been skipped by the pass operation is not assigned to the annotator who has performed the pass operation. More specifically, the task setting unit 112 sets the next and subsequent tasks of the annotator such that the target image belonging to the same group as the target image whose annotation has been skipped is not assigned to the annotator who has performed the pass operation.

The task setting unit 112 determines the difficulty level (difficulty) of the annotation with respect to each of the target images based on the number of times of executions of the pass operation executed on the target image or the number of annotators who have performed the pass operation on the target image. The task setting unit 112 stores the determined difficulty level information indicating the difficulty level of the annotation of each of the target images in the image DB 121 together with the image ID of each target image. The pass operation is an operation for skipping an annotation for a target image being displayed, and is input by the annotator via the annotator terminal 2. The pass operation will be described later.

The quality analysis unit 113 monitors the annotation of the annotator. More specifically, the quality analysis unit 113 monitors the required work time of the annotator and the quality of the annotation information. Note that the monitoring may be performed in real time or may be performed every predetermined period.

The quality analysis unit 113 monitors the work time of the annotator based on the annotator information recorded in the annotator DB 122, more specifically, the work history information. In addition, the quality analysis unit 113 monitors the quality of the annotation information (segmentation information and labeling information) given to the target image by the annotator using correct data (ground truth) created by Computer Graphics (CG) or the like. Specifically, the quality analysis unit 113 evaluates that the quality of the segmentation information is higher as the protruding amount of the segmentation or the size of the margin is smaller than the correct data. Furthermore, the quality analysis unit 113 evaluates that the quality of the labeling information is higher as the number of times of detection of the labeling error or the labeling omission is smaller.

The quality analysis unit 113 stores the work time statistical information indicating the monitoring result of the work time of the annotator and the quality information indicating the monitoring result of the quality of the annotation information in the annotator DB 122. The quality analysis unit 113 further generates skill information indicating the level of the annotation skill of the annotator based on the monitoring result of the quality of the annotation information, and stores the skill information in the annotator DB 122. Note that the higher the quality of the annotation information given to the target image by the annotator, the higher the quality analysis unit 113 evaluates the annotation skill of the annotator.

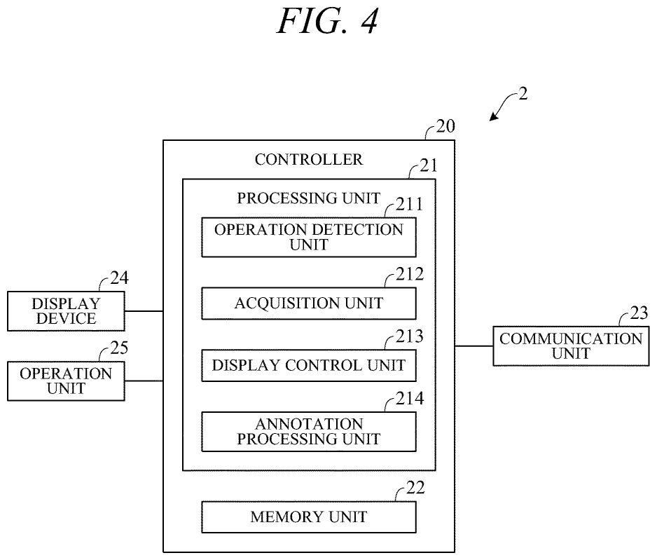

FIG. 4 is a block diagram illustrating a configuration of a main part of the annotator terminal 2 in FIG. 1. The annotator terminal 2 includes a controller 20, a communication unit 23, a display device 24, and an operation unit 25.

The communication unit 23 is a communication interface that connects the annotator terminal 2 to the communication network 3. The annotator terminal 2 transmits and receives information to and from the management apparatus 1 and the like connected to the communication network 3 via the communication unit 13.

The display device 24 is configured by a liquid crystal display, an organic EL display, or the like including a touch panel. The operation unit 25 is configured by a touch panel included in the display device 24, and is capable of inputting various instructions from the user. Note that the operation unit 25 may include an input device such as a switch or a button.

The controller 20 includes a computer including a processing unit 21 such as a CPU, a memory unit 22 such as a ROM and a RAM, and other peripheral circuits (not illustrated) such as an I/O interface. The processing unit 21 functions as an operation detection unit 211, an acquisition unit 212, a display control unit 213, and an annotation processing unit 214 by executing a program stored in the memory unit 22.

The operation detection unit 211 detects an operation (hereinafter expressed as a user operation) of the annotator input through operation unit 25.

At the time of starting work, the annotator activates a predetermined application (hereinafter referred to as a work application) installed in advance in the memory unit 22 via the operation unit 25. When the work application is activated, a login screen (not illustrated) of the work application is displayed on the display device 24. The annotator performs a login operation including input of an annotator ID with respect to the login screen via the operation unit 25.

When the operation detection unit 211 detects the login operation, the acquisition unit 212 transmits a login request together with the input annotator ID to the management apparatus 1 via the communication unit 13. The acquisition unit 212 receives a series of target images, window setting information, and mask setting information transmitted from the task management unit 111 of the management apparatus 1 in response to the login request.

After the login operation, when the annotator presses a work start button (not illustrated) displayed on the display device 24 via the operation unit 25, the display control unit 213 starts displaying the target image on display device 24. The display control unit 213 displays the series of target images acquired by the acquisition unit 212 on the display device 24 while switching the series of target images. The annotator adds annotation information, that is, segmentation information and labeling information to the target images sequentially displayed on the display device 24 via the operation unit 25.

When a predetermined time has elapsed from the start of display of the target image, or when a pass operation is detected by the operation detection unit 211 while the target image is being displayed, the display control unit 213 switches the display to the next target image. The pass operation is a predetermined operation for skipping an annotation with respect to an image being displayed, and is, for example, a flick.

Furthermore, when displaying the target image on the display device 24, the display control unit 213 displays the work window on the target image in an overlapping manner based on the window setting information. The display control unit 213 further scans the work window on the target image. As the scanning method, a sliding window method of scanning from the upper left to the lower right of the image may be used, or other methods may be used.

Furthermore, at the time of displaying the target image on the display device 24, the display control unit 213 displays, in an overlapping manner, the mask consisting of pixels of a single color on the position of the object in the target image based on the mask setting information so that the object to which the annotation information has already been added cannot be visually recognized.

When the segmentation operation is detected by the operation detection unit 211, the annotation processing unit 214 generates segmentation information based on the display position of the work window at the time point of detection. More specifically, the annotation processing unit 214 acquires position coordinates of a corner or a center of the work window as the segmentation information. The segmentation operation is a predetermined operation for inputting segmentation information, and is, for example, an operation of tapping the inner side of the work window slidably moving on the target image. Alternatively, the annotator may input the contour of the object on the display device or arrange a bounding box.

When the series of target images acquired by the acquisition unit 212 is classified based on the type of the object included in the image, the annotation processing unit 214 acquires the type as the labeling information. Note that when a series of target images is classified based on the imaging environment, the annotation processing unit 214 may acquire the type of an object assumed from the imaging environment as the labeling information. For example, in a case where the imaging environment is “highway”, “vehicle” is acquired as the labeling information.

Furthermore, when the type of the object is input by the annotator via the operation unit 25, the annotation processing unit 214 may acquire the input type of the object as the labeling information. In this case, the annotator operates a label selection screen (not illustrated) via the operation unit 25 to input the type of the object. When the segmentation operation is detected by the operation detection unit 211, the label selection screen is displayed in the vicinity of the work window by the display control unit 213. A plurality of types of the object are displayed on the label selection screen, and when one of the types is tapped, the annotation processing unit 214 acquires the tapped type of the object as the labeling information.

When a work end operation is detected by the operation detection unit 211, the annotation processing unit 214 transmits a work end notification to the management apparatus 1 via the communication unit 13. At this time, the annotation processing unit 214 transmits the performance information indicating the work performance of the annotator to the management apparatus 1 together with the work end notification. The work end operation is a predetermined operation indicating the end of the work, and is, for example, an operation of pressing a work end button (not illustrated) displayed on the display device 24.

The performance information includes work time information indicating a time required for the annotator to add the annotation information (a time from when the target image is displayed to when the next target image is displayed) and pass operation history information indicating the presence or absence of the pass operation in association with the image ID of each of the series of target images. In addition, the performance information includes annotation information attached to the target image.

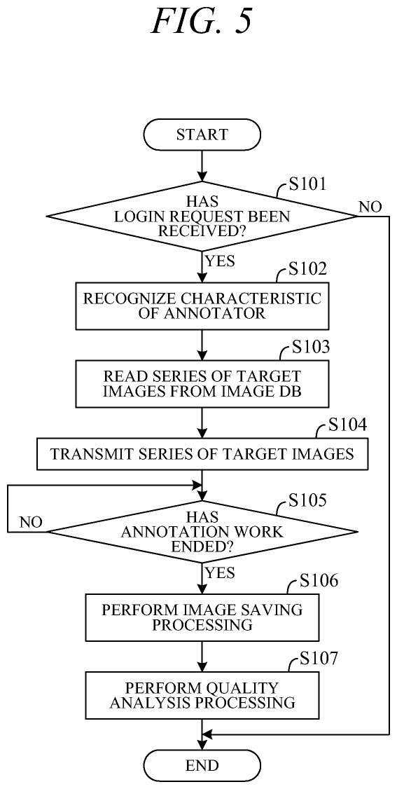

FIG. 5 is a flowchart illustrating an example of processing executed by the controller 10 of the management apparatus 1 in accordance with a program defined in advance. The processing illustrated in the flowchart is started when the controller 10 is activated, and is repeated at a predetermined cycle.

First, in step S101, the controller 10 determines whether or not a login request has been received from the annotator terminal 2. In a case where a negative determination is made in step S101, the controller 10 ends the processing. In a case where an affirmative determination is made in step S101, in step S102, the controller 10 performs the login authentication based on the annotator ID and the password associated with the login request, and when the login authentication is successful, acquires the characteristic information of the annotator from the annotator DB. When the login authentication fails, the controller 10 ends the processing.

The controller 10 recognizes the characteristic of the annotator based on the acquired characteristic information. Specifically, the controller 10 recognizes the level of the annotation accuracy of the annotator based on the skill information included in the characteristic information. In addition, the controller 10 recognizes a work target (image) that the annotator is not good at based on the tendency information included in the characteristic information.

In step S103, the controller 10 reads, from the image DB 121, a series of target images in which the difficulty level of the annotation corresponds to the level of the annotation skill of the annotator. At this time, the controller 10 extracts a series of target images based on the tendency information included in the characteristic information such that an image that the annotator is not good at is excluded or an image that the annotator is good at is included.

In step S104, the controller 10 transmits the series of target images acquired in step S103 to the annotator terminal 2. In step S105, the controller 10 determines whether or not the work of the annotator on the series of target images transmitted in step S104 has ended. At this time, the controller 10 determines that the work has ended when receiving the work end notification from the annotator terminal 2. The work end notification is accompanied by performance information indicating performance of the work of the annotator.

The processing of step S105 is repeated until an affirmative determination is made. When an affirmative determination is made in step S105, the controller 10 executes the image saving processing (step S106) and the quality analysis processing (step S107), and ends the processing.

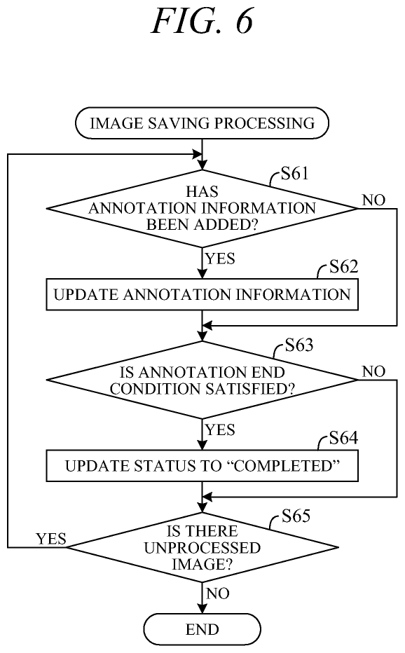

FIG. 6 is a flowchart illustrating an example of processing (image saving processing) in step S106 of FIG. 5. The controller 10 executes the processing of steps S61 to S64 on each of the series of target images acquired in step S103, that is, the series of target images serving as the target of annotation.

First, in step S61, the controller 10 determines, based on the performance information, whether or not new annotation information has been added to the target image, in other words, whether or not the pass operation has not been executed on the target image. In a case where an affirmative determination is made in step S61, the controller 10 proceeds to the processing of step S63.

In a case where an affirmative determination is made in step S61, the annotation information added to the target image included in the performance information is saved in the image DB 121 in association with the image ID of the target image in step S62. At this time, in a case where the annotation information corresponding to the image ID is already stored in the image DB 121, the controller 10 updates the annotation information stored in the image DB 121.

In step S63, the controller 10 determines whether or not the target image satisfies the annotation end condition. The annotation end condition is determined by whether or not the annotation information is added to all objects in the target image, specifically, all objects corresponding to the type designated in advance as the annotation information addition target. The annotation end condition may also be determined by whether all the preset work window sizes have been applied.

In a case where a negative determination is made in step S63, the controller 10 proceeds to the processing of step S65. In a case where an affirmative determination is made in step S63, the controller 10 updates the status information corresponding to the target image stored in the image DB 121 to “completed” in step S64. The initial value of the status information is “not completed”. The target image of which the status information is updated to “completed” is thereafter treated as a processed image.

In step S65, the controller 10 determines whether or not there is an unprocessed target image. In a case where an affirmative determination is made in step S65, the controller 10 repeats the processing of steps S61 to S64 on the unprocessed target image. In a case where a negative determination is made in step S65, the controller 10 ends the processing.

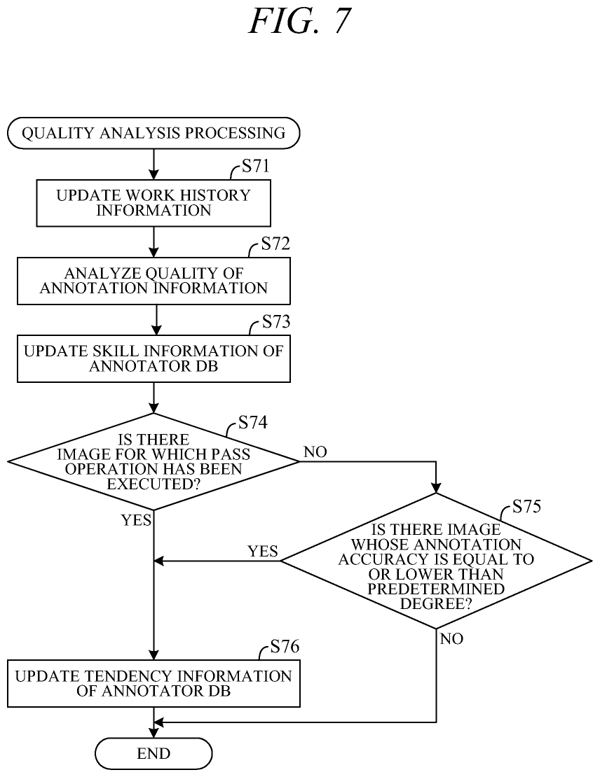

FIG. 7 is a flowchart illustrating an example of processing (quality analysis processing) in step S107 of FIG. 5.

First, in step S71, the controller 10 updates the work history information recorded in the annotator DB 122 based on the work time information of each target image included in the performance information received in step S105.

In step S72, the controller 10 analyzes the quality of the annotation information of each target image included in the performance information received in step S105 using the correct data (Ground Truth) created in advance. In step S73, the controller 10 updates the skill information of the annotator stored in the annotator DB 122 based on the analysis result in step S72. In step S74, the controller 10 determines whether or not there is a target image for which the pass operation has been executed based on the pass operation history information included in the performance information.

In a case where an affirmative determination is made in step S74, the controller 10 updates the number of passes information recorded in the annotator DB 122 based on the pass operation history information, and proceeds to step S76. In a case where a negative determination is made in step S74, the controller 10 determines in step S75 whether or not there is a target image whose annotation accuracy is equal to or lower than a predetermined degree based on the analysis result in step S72. In a case where a negative determination is made in step S75, the processing ends. In a case where an affirmative determination is made in step S75, in step S76, the controller 10 updates the tendency information of the annotator stored in the annotator DB 122, and ends the processing.

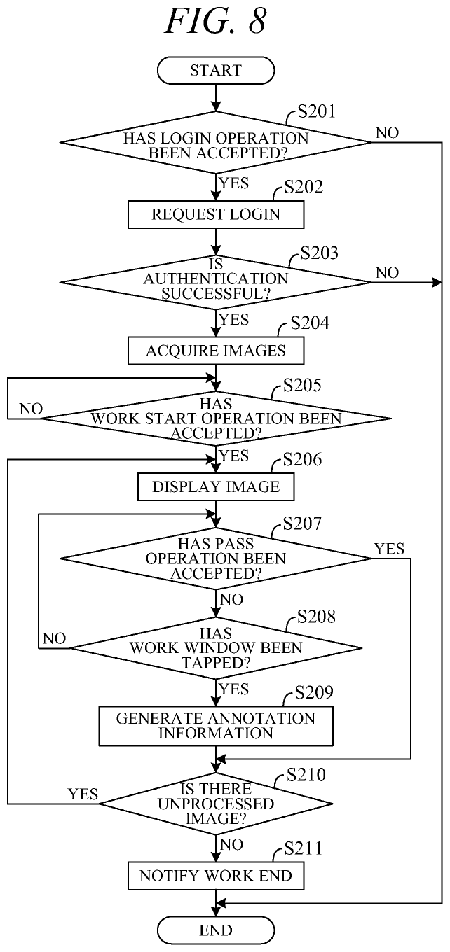

FIG. 8 is a flowchart illustrating an example of processing executed by the controller 20 of the annotator terminal 2 according to a program defined in advance. The processing illustrated in the flowchart is started when the work application is activated, and is repeated at a predetermined cycle.

First, in step S201, the controller 20 determines whether or not a login operation has been accepted via the operation unit 25. In step S202, the controller 20 transmits a login request (authentication request) to the management apparatus 1 together with the annotator ID and the password input in the login operation. In step S203, the controller 20 determines whether or not the authentication is successful. In a case where a negative determination is made in step S201 or S203, the processing ends.

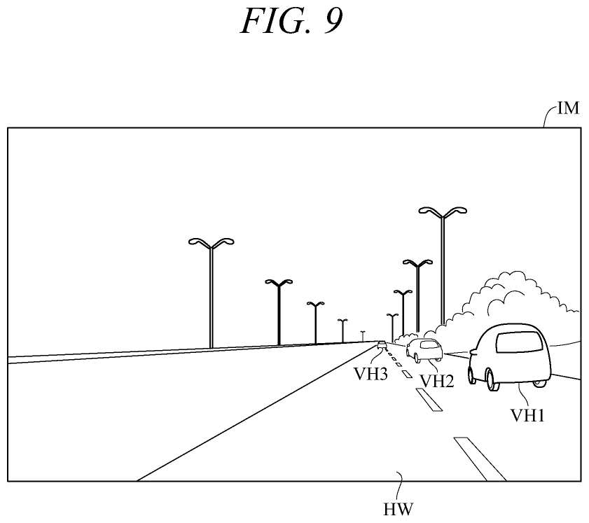

When an affirmative determination is made in step S203, in step S204, the controller 20 acquires a series of target images transmitted from the management apparatus 1 in response to the login request. In addition, the controller 20 acquires window setting information and mask setting information associated with a series of target images. Note that, here, a case where an image including a vehicle is acquired as a series of target images is taken as an example. FIG. 9A is a diagram illustrating an example of a target image including a vehicle. FIG. 9A illustrates an image IM acquired by the in-vehicle camera of the vehicle traveling on the highway HW. As illustrated in FIG. 9A, the target image includes front vehicles VH1, VH2, and VH3.

When the series of target images is acquired, the controller 20 displays a work start screen (not illustrated) on the display device 24. The work start screen includes a work start button and a message (e.g., “Tap the window at the timing when the car is included in the square window”) for explaining work contents to the annotator. When starting a work, the annotator presses a work start button via the operation unit 25.

In step S205, the controller 20 determines whether or not the work start button has been pressed. The processing of step S205 is repeated until an affirmative determination is made. When an affirmative determination is made in step S205, in step S206, the controller 20 displays the target image on which the work window having the designated shape and size is superimposed on the display device 24 based on the window setting information. In addition, the controller 20 scans the work window on the target image according to a designated scanning method based on the window setting information. Furthermore, the controller 20 superimposes and displays a mask on the target image as necessary based on the mask setting information.

FIGS. 10A to 10C are diagrams illustrating examples of target images displayed on the display device 24. FIG. 10A illustrates a target image on which a work window WD is superimposed. As illustrated in FIG. 10A, a region other than the work window WD is displayed with a lower transparency than the work window. As a result, the annotator can easily recognize the work window WD superimposed and displayed on the target image IM. Note that a region other than the work window WD is displayed with a transparency of equal to or greater than a predetermined value so that the annotator can confirm the content of the target image. That is, a region other than the work window WD is displayed with a transparency equal to or greater than a predetermined value and lower than the work window.

Furthermore, as illustrated in FIG. 10A, the work window WD slidably moves on the target image IM. A work window indicated by an outlined arrow and a broken line in the drawing schematically represents a state in which the work window WD is slidably moving. When the scanning method is the sliding window method, the work window WD slidably moves from the upper left to the lower right of the target image IM.

In step S207, the controller 20 determines whether or not a pass operation has been accepted via the operation unit 25. When an affirmative determination is made in step S207, the controller 20 proceeds to the processing of step S210. When a negative determination is made in step S207, in step S208, whether or not a tap operation on the work window has been detected is determined.

When a negative determination is made in step S208, the controller 20 returns to the processing of step S207. When an affirmative determination is made in step S208, in step S209, the controller 20 generates segmentation information based on the position coordinates, the shape, and the size of the work window at the time point of tap operation detection. The controller 20 also generates labeling information indicating the type (in this example, the vehicle) of the object in the work window. Furthermore, the controller 20 generates the annotation information based on the segmentation information and the labeling information.

FIG. 10B illustrates a state where the work window WD slidably moves and reaches the position of the vehicle VH1. In the display state of FIG. 10B, when the annotator taps the work window WD, annotation information corresponding to the vehicle VH1 is generated based on the position coordinates, the shape, and the size of the work window WD. In the next and subsequent annotations with respect to the target image IM, a region corresponding to the vehicle VH1 for which the annotation information has already been generated is masked. FIG. 10C illustrates the target image IM in which the mask MR is superimposed and displayed on the region corresponding to the vehicle VH1.

In step S210, the controller 20 determines whether or not there is an unprocessed target image. When an affirmative determination is made in step S210, the controller 20 returns to the processing of step S206. When a negative determination is made in step S210, in step S211, the controller 20 transmits a work end notification to the management apparatus 1.

According to the embodiments described above, the following operations and effects can be obtained.
(1) The management apparatus 1 includes a task management unit 111 for assigning a task of adding annotation information to an object in an image to an annotator (worker), a memory unit 12 serving as a storage device for storing a target image that is an image to which the annotation information is to be added by the annotator, and a task setting unit 112 for setting the task so as to add the annotation information to one object included in the target image. The task management unit 111 stores the information of the task set by the task setting unit 112 in the memory unit 12 in association with the target image. As a result, the annotator only needs to add the annotation information to one object for each target image, so that the annotation can be advanced at a good tempo.
(2) The task setting unit 112 sets a task such that annotation information is added to a plurality of target images, in each of which an object of the same type is included, stored in the memory unit 12. This allows the annotator to successively process objects of the same type. As a result, a reduction in the cognitive load of the annotator is expected.
(3) The task setting unit 112 sets the task such that the annotation information is added to the object in the work window having the predetermined size superimposed and displayed on the target image. This eliminates the need for the annotator to check the region outside the work window and allows the annotator to concentrate on the object within the work window.
(4) The task setting unit 112 further sets the task such that a region other than the work window is displayed with a lower transparency than the work window. As a result, the annotator can visually recognize the region outside the work window, and can advance the annotation while understanding the scene in which the target image is imaged.
(5) The task setting unit 112 sets a task such that a plurality of windows having different sizes are applied to one target image. This makes it easier to detect the object with a window suitable for the size of the object.
(6) The task setting unit 112 further sets the task such that a region other than the region corresponding to the object to which the annotation information is added in the target image is masked. As a result, it is possible to reduce the region to be the target of the annotation.
(7) An annotator terminal 2 having a communication unit 23 that communicates with the management apparatus 1 is provided. The annotator terminal 2 includes a display device 24, an acquisition unit 212 for acquiring a series of target images stored in a memory unit 12 of the management apparatus 1 via the communication unit 23, a display control unit 213 for displaying the series of target images acquired by the acquisition unit 212 on the display device 24 while switching the series of target images, and an operation detection unit 211 for detecting an operation (hereinafter referred to as a user operation) of the annotator on the target image displayed on the display device 24. When a predetermined time elapses after the target image is displayed, or when a predetermined user operation is detected by the operation detection unit 211 while the target image is being displayed, the display control unit 213 switches the display to the next target image. As a result, the annotator can pass an annotation for an image in which the difficulty level of work is high, so that the work can be advanced with a good tempo.
(8) When display switching is performed by the display control unit 213 according to a predetermined user operation, the task setting unit 112 sets a next or subsequent task to be assigned to the annotator such that the target image displayed before the display switching is not a target of addition of annotation information by the annotator. As a result, an image the annotator is not good at is not presented again, and improvement in work efficiency of the annotator is expected.
(9) Each target image is classified into groups based on at least one of the imaging environment and the type of the object in the image and stored in the memory unit 12. The task setting unit 112 sets a next or subsequent task to be assigned to the annotator such that a target image classified into the same group as the target image before display switching is not to be an addition target of annotation information by the annotator. As a result, an image the annotator is not good at is not presented again, and improvement in work efficiency of the annotator is expected.
(10) The task setting unit 112, as a determination unit, determines a difficulty level of adding annotation information to each target image based on the number of times of display switching executed for each target image or the number of annotators who have performed a predetermined user operation on each target image. The task setting unit 112 further stores difficulty level information indicating the difficulty level of each target image in the memory unit 12. In this way, an appropriate task can be assigned to the annotator by managing the difficulty level for each target image.
(11) The memory unit 12 stores work history information indicating a work history of the annotator and further includes a quality analysis unit 113 serving as a generation unit for generating characteristic information indicating a work characteristic of the annotator based on the work history information stored in the storage device. The characteristic information includes information indicating the level of work skill of the annotator. The quality analysis unit 113 stores the characteristic information in the memory unit 12 in association with the work history information. In this way, an appropriate task can be assigned to the annotator by managing the working characteristics of the annotator.
(12) The quality analysis unit 113 further analyzes the quality of the annotation information added to the target image. The quality analysis unit 113 stores quality information indicating a quality analysis result in the memory unit 12. As a result, the task can be managed based on the quality analysis result.
(13) The task management unit 111 further detects a change in the work time of the annotator based on the work history information, detects a change in the work quality of the annotator based on the quality information, generates condition information indicating a work condition of the annotator based on the detected change in the work time or the detected change in the work quality, and stores the condition information in the storage device. In this way, the state change of the annotator can be detected by monitoring the state of the annotator. As a result, the annotator can recognize his/her own condition (physical condition or concentration) by continuing the annotation work.
(14) The task management unit 111 assigns a target image having a high difficulty level to an annotator having a high work skill based on the characteristic information and the difficulty level information stored in the memory unit 12. This is expected to improve the efficiency of the annotation.

In a case where the annotator is not used to an operation of a device such as a tablet terminal or a personal computer (PC), it is difficult to smoothly perform the annotation work using the tablet terminal or the like. Furthermore, it is more difficult in a case where the annotator is unfamiliar with the annotation itself. Therefore, in order to deal with such a problem, the information processing system 100 is configured as follows.

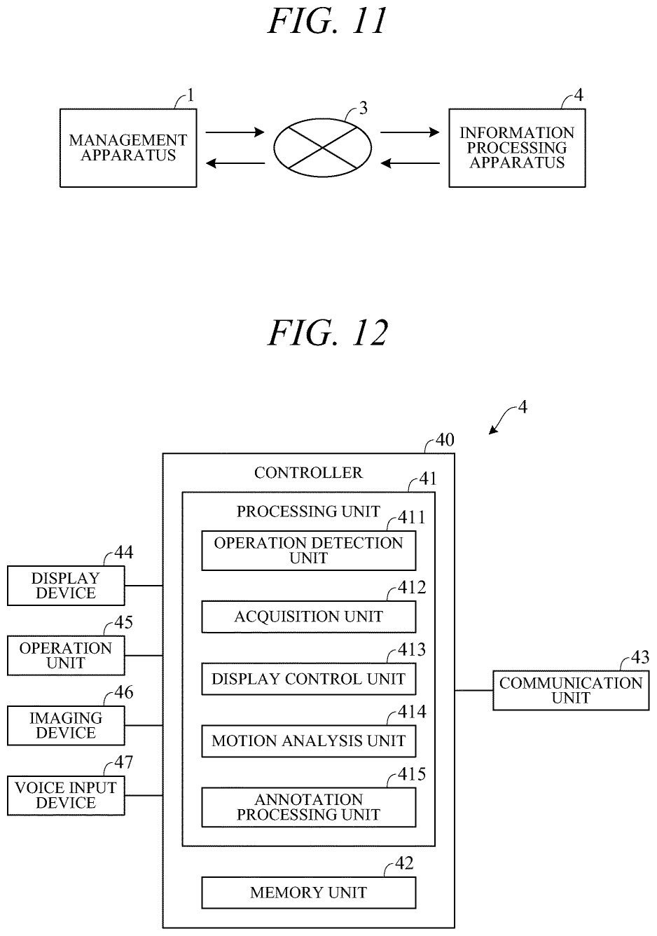

FIG. 11 is a block diagram schematically illustrating another example of the overall configuration of the information processing system 100 including the management apparatus 1. An information processing system 100 in FIG. 11 includes a management apparatus 1 and an information processing apparatus 4 communicably connected to the management apparatus 1 via a communication network 3. Note that although FIG. 11 illustrates one information processing apparatus 4, a plurality of information processing apparatuses 4 may be connected to the management apparatus 1 via the communication network 3. Note that the information processing system 100 may include the annotator terminal 2 in FIG. 1.

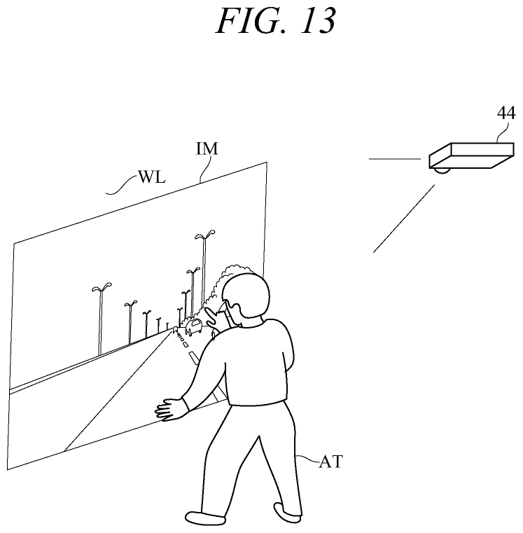

FIG. 12 is a block diagram illustrating a configuration of a main part of the information processing apparatus 4 of FIG. 11. The information processing apparatus 4 includes a controller 40, a communication unit 43, a display device 44, an operation unit 45, an imaging device 46, and a voice input device 47.

The communication unit 43 is a communication interface that connects the information processing apparatus 4 to the communication network 3. The information processing apparatus 4 transmits and receives information to and from the management apparatus 1 and the like connected to the communication network 3 via the communication unit 13.

The display device 44 is a projection device (projector) that projects an image. In the display device 44, internal parameters (focal length etc.) and external parameters (position, posture, etc.) are calibrated in advance such that an image is projected onto a predetermined region on a wall surface existing in a space.

The imaging device 46 includes an imaging element such as a CCD or a CMOS, and converts light into an electrical signal to acquire an image. The imaging device 46 images the motion of the annotator or the movement of the work tool according to the motion with respect to the target image projected (displayed) onto the predetermined region by the display device 44. The work tool is, for example, a pointing stick.

The voice input device 47 is, for example, a microphone, and inputs the voice of the annotator as a voice signal. The voice signal input by the voice input device 47 is output to the processing unit 41 as voice data via an A/D converter (not illustrated).

The controller 40 includes a computer including a processing unit 41 such as a CPU, a memory unit 42 such as a ROM and a RAM, and other peripheral circuits (not illustrated) such as an I/O interface. The processing unit 41 functions as an operation detection unit 411, an acquisition unit 412, a display control unit 413, a motion analysis unit 414, and an annotation processing unit 415 by executing a program stored in the memory unit 42. The memory unit 42 stores motion information to be described later.

The motion analysis unit 414 analyzes the motion of the annotator imaged by the imaging device 46. More specifically, the motion analysis unit 414 analyzes the motion of a predetermined part (e.g., a fingertip) of the annotator or the movement of the work tool according to the motion of the annotator based on the captured image acquired by the imaging device 46.

The operation detection unit 411, the acquisition unit 412, the display control unit 413, and the annotation processing unit 415 have configurations similar to those of the operation detection unit 211, the acquisition unit 212, the display control unit 213, and the annotation processing unit 214 in FIG. 4. However, the operation detection unit 411, the display control unit 413, and the annotation processing unit 415 are different from the operation detection unit 211, the display control unit 213, and the annotation processing unit 214 in FIG. 4 in the following points.

The operation detection unit 411 detects an annotation operation corresponding to the motion of the annotator or the movement of the work tool in addition to the operation (login operation etc.) of the annotator input via the operation unit 45. Specifically, the operation detection unit 411 detects the annotation operation corresponding to the motion of the annotator or the movement of the work tool based on the motion information stored in the memory unit 42 and the analysis result of the motion analysis unit 414.

The motion information is information in which the annotation operation is associated with the motion (tap, double tap, swipe, drag, etc.) of the annotator or the movement of the work tool. The annotation operation includes a segmentation operation and a labeling (attribute addition) operation.

The segmentation operation includes an operation of cutting out a contour of an object and an adjustment operation. For example, when the annotator performs a motion of tracing the contour of the object in the target image with the finger or the pointing stick, the position of the distal end of the fingertip or the pointing stick is tracked by the motion analysis unit 414. The operation detection unit 411 detects the contour cut-out operation by the annotator based on the analysis result (tracking result) of the motion analysis unit 414.

FIG. 13 is a diagram for explaining the annotation operation. FIG. 13 illustrates a state in which the annotator AT performs annotation on the target image IM projected onto the wall surface WL by the display device 44. As illustrated in FIG. 13, when the annotator AT traces the contour of the object in the target image IM with the finger, the movement of the fingertip is analyzed by the motion analysis unit 414, and the contour cut-out operation is detected by the operation detection unit 411.

Segmentation may be performed by adjusting the shape and size of a bounding box (hereinafter simply referred to as a box) superimposed on a target image so as to include an object. In this case, the segmentation operation includes an adjustment operation of the box. The operation detection unit 411 detects a gesture of the annotator AT for enlarging or reducing the box as an adjustment operation of the box.

In addition, the segmentation may be performed by inputting a box including an object in the target image. In this case, the segmentation operation includes an input operation of a box. The operation detection unit 411 detects a motion in which the annotator AT touches two points on the target image with a finger or a pointing stick as an input operation of the box. In this case, the two touched points are designated as the upper right corner and the lower left corner of the box.

The display control unit 413 outputs the target image to the display device 44, and controls the display device 44 so that the target image is projected onto a predetermined region. Furthermore, when the segmentation operation is detected by the operation detection unit 411, the display control unit 413 projects a label selection screen (not illustrated) so as to be superimposed on the target image.

When the segmentation operation is detected by the operation detection unit 411, the annotation processing unit 415 generates segmentation information based on the display position of the region designated by the contour cut-out operation or the box input operation.

When any of the types of the plurality of objects displayed on the label selection screen is touched (tapped) by the annotator, the annotation processing unit 415 acquires the type of the touched object as the labeling information. Note that the annotator AT may designate any of the types of a plurality of objects displayed on the label selection screen by voice. In this case, the annotation processing unit 415 recognizes the voice of the annotator AT input via the voice input device 47, and generates the labeling information based on the recognition result.

Note that when the contour cut-out operation of the annotator AT is detected by the operation detection unit 411, the display control unit 413 may superimpose the trajectory of the position of the finger of the annotator AT or the pointing stick tracked by the motion analysis unit 414 on the target image. Thus, the person around the annotator AT can confirm whether the contour cut-out is good or bad. In addition, when the annotator AT holds the palm over the trajectory superimposed on the target image, the superimposition and display of the trajectory included in the range over which the palm is held may be released.

Furthermore, when projecting the target image onto the predetermined region, the display control unit 413 may project the work window onto the target image projected onto the predetermined region in an overlapping manner and scan the work window on the target image based on the window setting information described above. In this case, the annotation processing unit 214 generates the segmentation information based on the display position of the work window when the segmentation operation is detected. Furthermore, when projecting the target image onto the predetermined region, the display control unit 413 may project the mask onto the target image projected onto the predetermined region in an overlapping manner based on the mask setting information described above.

According to the embodiments described above, the following operations and effects can be obtained.
(1) The information processing apparatus 4 generates annotation information to be added to a target image. The information processing apparatus 4 includes a display device 44 for displaying an image with a predetermined region in space as a display region, a display control unit 413 that controls the display device 44 such that a target image is displayed in the predetermined region, an imaging device 46 for imaging a motion of a worker or a movement of a work tool according to the motion with respect to the target image displayed in the predetermined region, a motion analysis unit 414 for analyzing the motion of the worker or the movement of the work tool imaged by the imaging device 46, and an annotation processing unit 415 for generating annotation information to be added to an object in the target image based on an analysis result of the motion analysis unit 414. As a result, the annotator can perform annotation on the target image projected onto the wall or the floor.
(2) The predetermined region is a region on a wall surface existing in the space, the display device 44 is an image projection device, the display control unit 413 controls the display device 44 so that the target image is projected onto the predetermined region, and the motion analysis unit 414 analyzes the movement of the predetermined part of the annotator based on the imaged image acquired by the imaging device 46. As a result, the target image is projected onto the wall surface, so that the surrounding person can confirm the target image and the annotation information added to the target image. In addition, segmentation is performed on a large target image projected onto the wall surface, so that the accuracy of segmentation is expected to be improved.
(3) The information processing apparatus 4 further includes an operation detection unit 411 for detecting an operation corresponding to the motion of the annotator or the movement of the work tool based on the motion information in which a plurality of operations associated with the annotation and a plurality of motions of the worker are associated with each other and an analysis result of the motion analysis unit 414. The annotation processing unit 415 generates annotation information to be added to an object in the target image according to the operation detected by the operation detection unit 411. In this way, a plurality of motions of the annotator can be associated with different annotation operations, and operability of the annotator is improved.

The above embodiments may be modified into various modes. Hereinafter, modified examples will be described. In the above embodiment, the task setting unit 112 sets, as a setting unit, a task so as to add annotation information to one object included in a target image. However, the setting unit may set the task so as to add the annotation information to a predetermined number of objects included in the target image. In this case, the setting unit includes, in the work window setting information, information designating the number of work windows such that the work window of a number corresponding to the predetermined number is superimposed and displayed on the target image. In this case, an affirmative determination is not made in the processing in step S208 in FIG. 8 until all the work windows are tapped. At this time, the superimposed display of the tapped work windows may be released, or a predetermined mark indicating that the annotation has been completed may be superimposed and displayed on the tapped work window. As a result, even if a plurality of objects are included in one image, it is not necessary for the annotator to determine how far to work. Note that the work windows of a number corresponding to a predetermined number superimposed on the target image may be different from each other in size.

Furthermore, in the above embodiment, when the annotator taps the rectangular work window displayed on the target image, the annotation processing unit 214 acquires the position coordinates of the corner and the center of the work window as the segmentation information. However, the annotator may adjust the shape of the work window to match the contour of the object in the work window after tapping the work window. More particularly, the annotator may tap a plurality of points along the contour of the object to adjust the position and number of vertices of the work window. In this case, the annotation processing unit generates segmentation information based on the work window whose shape has been adjusted.

In the above embodiment, the task setting unit 112 serving as the setting unit sets the work window for the target image. However, the setting unit may set a temporary contour line instead of the work window for the target image. The temporary contour line is a contour line that roughly includes an object in the image. In this case, the annotator adjusts the segmentation by changing the position of the vertex of the temporary contour line.

Furthermore, in the above embodiment, the task setting unit 112 serving as a setting unit determines the difficulty level of the annotation for the target image based on the number of executions of the pass operation executed for the target image or the number of annotators who have performed the pass operation for the target image. However, the setting unit may give an incentive to the target image based on the determined difficulty level. For example, the work unit price of the annotation for the target image having a high difficulty level may be set higher. In this case, the setting unit may store the information of the incentive set to the target image in the image DB 121 in association with the image ID of the target image.

Furthermore, in the above-described embodiment, an example has been described in which the motion analysis unit 414 analyzes, as the analysis unit, the movement of the pointing stick serving as the work tool based on the imaged image acquired by the imaging device 46. However, a tool other than the pointing stick may be used as the work tool.

For example, a tool that emits an electromagnetic wave of a specific wavelength may be used as the work tool. In this case, the analysis unit analyzes the movement of the electromagnetic wave emitted by the work tool and imaged by the imaging device 46.

As a specific example, a pulse irradiation type laser gun may be used as the work tool. In this case, the annotator AT operates the laser gun so as to irradiate the laser in a scattered manner along the contour of the object on the target image. The motion analysis unit 414 detects, as an arrival detection unit, the arrival of the laser emitted from the laser gun at a predetermined region on the wall surface WL, more specifically, the arrival time point and the arrival position based on the imaged image of the imaging device 46. When the arrival detection unit detects the arrival of the laser, the display control unit 413 controls the display device 44 to superimpose and display a predetermined image on a region including the arrival position of the laser. More specifically, the display control unit 413 controls the display device 44 so as to project an image (hereinafter referred to as a gun mark image) imitating a gun mark onto the arrival position of the laser. The annotation processing unit 415 generates segmentation information based on each arrival position of the laser.

The display control unit 413 may project, together with the gun mark image, an image imitating a droplet flowing downward from the gun mark as (hereinafter referred to as a droplet image) and superimpose and display the droplet image on the target image. At that time, the display control unit 413 may change the droplet image so that the droplet extends downward according to the elapsed time from the arrival time point of the laser.

Instead of the laser gun, an injection device of a game ball (so-called pachinko ball) may be used. In this case, the motion analysis unit 414 serving as an arrival detection unit detects the arrival (arrival time point and arrival position) of the game ball to the wall surface WL based on the imaged image of the imaging device 46, and when the arrival of the game ball is detected, the display control unit 413 superimposes and displays a predetermined image (e.g., a colored circle having the same size as the game ball) on the arrival position.

Furthermore, for example, darts may be used as a work tool. When a dart is used as a work tool, the wall surface WL is made of a material into which the dart can be inserted. In a case where the dart is used as the work tool, the motion analysis unit 414 serving as the arrival detection unit detects the arrival position of the dart at the wall surface WL based on the imaged image of the imaging device 46, and the annotation processing unit 415 generates segmentation information based on each arrival position of the dart.

When the arrival of the dart is detected, the display control unit 413 may superimpose and display a predetermined image (e.g., an image imitating light emission) on the arrival position. In addition, in a case where the laser gun has a communication function and a vibration function, the display control unit 413 may output a vibration instruction to the laser gun via the communication unit 43 to vibrate the laser gun when an arrival of the laser at the wall surface is detected.

In addition, the display control unit 413 may output a sound effect or the like as an acoustic control unit when arrival of a projection body such as a laser, a game ball, a dart, or the like at the wall surface is detected. In this case, the acoustic control unit controls an acoustic generation device (not illustrated) that generates a sound corresponding to the input acoustic data to control generation of the sound. The motion analysis unit 414 serving as an arrival detection unit detects the arrival of the projection body such as the electromagnetic wave emitted from the laser gun at a predetermined region, and when the arrival of the projection body is detected by the detection unit, the acoustic control unit outputs acoustic data corresponding to a predetermined sound such as a sound effect to the acoustic generation device.

As described above, according to the method of generating the segmentation information based on the arrival position of the projection body, the segmentation can be performed by the plurality of annotators for one target image or one object in the target image. As a result, a plurality of annotators can compete in the segmentation time and the segmentation accuracy. For example, the entertainment property or the game property can be added to the annotation work by setting an annotator with high segmentation accuracy as a winner, or by setting an annotator closer to a preset segmentation accuracy as a winner. Furthermore, in a case where segmentation is performed by a plurality of annotators, it is possible to further improve the entertainment property and the game property of the annotation work by enabling the annotators to compete in the number and accuracy of labeling.

In the above embodiment, the internal parameters and the external parameters of the display device 44 serving as the image projection device are calibrated such that the target image is projected onto the predetermined region on the wall surface. However, the image projection device may be calibrated with internal and external parameters such that the target image is projected onto a predetermined region of the floor.

In this case, the annotator moves by walking or running along the contour of the object in the target image projected onto the floor. The motion analysis unit 414 tracks the movement trajectory of the annotator, and the operation detection unit 411 detects an operation of cutting out a contour with respect to an object in the target image based on the tracking result. Note that instead of moving along the contour of the object, the annotator may trace the contour with a rod-shaped member such as a pointing stick. The motion analysis unit 414 tracks the position of the distal end of the rod-shaped member, and the operation detection unit 411 detects the operation of cutting out the contour with respect to the object in the target image based on the tracking result.

Note that the annotator may cut out the contour of the object as if rubbing the entire inner region of the object in the target image projected onto the floor, like sweeping in curling using a brush with a handle. In this case, the display control unit may superimpose and display a predetermined image (e.g., brush marks) in the portion rubbed with the brush. In this way, by adding competitiveness to the annotation work, it is expected that even people who are not familiar with each other perform the annotation work in cooperation.

Furthermore, as described above, in a case where the game property and the competitiveness are added to the annotation work, the annotation processing unit 415 may measure the work time required to generate the annotation information for each annotator as the measurement unit, and compare the measured work times of each of the annotators. Then, the incentive giving unit may give an incentive based on the comparison result to each annotator. For example, the ranking of each annotator may be determined according to the work time. In particular, annotators with short work times may be ranked high. As a result, it is possible to further improve the entertainment property and the game property of the annotation work.

Furthermore, in the above embodiment, the case where the display device 44 serving as the image projection device projects the target image onto the wall surface has been described as an example. However, instead of the wall surface, the target image may be projected onto an electronic device having an input region that detects approach or contact of the input device. For example, the target image may be projected onto an electronic device such as a touch panel or an electronic whiteboard having a size capable of projecting an image by the image projection device. In this case, in the display device 44, the position of the display region is set in advance such that the input region of the electronic device becomes the display region. The annotator performs an operation of cutting out a contour of an object with a dedicated pen such as a touch pen on the target image projected onto the electronic device. The motion analysis unit 414 functions as a position detection unit to detect an approaching position or a contact position of the input device in the input region. For example, when the input device is a touch panel, the position detection unit detects an approaching position or a contact position of the input device based on a detection value of a sensor of the touch panel. The motion analysis unit 414 further analyzes a change in the detected approaching position or contact position as an analysis unit. The annotation processing unit 415 generates annotation information to be added to an object in the target image based on the analysis result of the analysis unit. More specifically, the operation detection unit 411 detects the operation of the annotator with respect to the target image projected onto the touch panel based on the analysis result of the analysis unit, and the annotation processing unit 415 generates the annotation information to be added to the object in the target image based on the detection result of the operation detection unit 411.

In addition, the target image may be projected onto a whiteboard instead of the wall surface. In this case, the annotator performs a contour cut-out operation or the like with the marker (felt-tip pen). The motion analysis unit 414 serving as an analysis unit tracks the positions of the tips of the pens, and the operation detection unit 411 detects the operation of the annotator based on the tracking result.

In the above embodiment, the case where the display device 44 serving as the image projection device projects the target image onto the two-dimensional wall surface has been described as an example. However, the display device may be a wearing-type device having a Virtual Reality (VR) function for displaying a three-dimensional virtual space based on the target image.

The wearing-type display device is a head mounted display (HMD) such as VR goggles. In this case, the display control unit 413 generates a VR video by binocular stereoscopic vision based on two target images simultaneously photographed by two imaging devices, and the display device reproduces the VR video. The method for generating the VR video is not limited thereto, and the VR video may be generated using a target image imaged by one imaging device and a sensor value of a distance sensor (not illustrated). The motion analysis unit 414 detects, as a detection unit, a position in the real space of a VR work tool (VR hand controller, VR glove, etc.) in which the position in the real space is calibrated with the position in the virtual space. The motion analysis unit 414 further analyzes, as an analysis unit, a change in the position in the virtual space of the work tool held by the annotator based on the detected position in the real space. More specifically, the analysis unit maps the detected position in the real space in the virtual space through predetermined coordinate transformation, and tracks the position of the work tool in the virtual space. The annotation processing unit 415 generates annotation information to be added to the object in the virtual section based on the analysis result of the analysis unit.

As a result, the annotator wearing the VR goggles can perform the annotation work in the three-dimensional virtual space. In a case where the target image is a two-dimensional image, there is a case where a region of one part in the target image cannot be visually recognized due to occlusion or the like. However, by using the above HMD, it is possible to confirm a region including a region that is difficult to visually recognize on a two-dimensional image, and improvement in the accuracy of the annotation by the annotator can be expected.

Note that the display control unit 413 may generate the VR video so that the scale of the object in the VR space matches the scale of the real space. This makes the object visible to the annotator in the same size as it actually is, so that a reduction in the cognitive load of the annotator is expected. Furthermore, the display control unit 413 may generate the VR video so that the scale of the object in the VR space is larger than the scale of the real space. As a result, even the details of the object can be segmented, and improvement in the accuracy of the annotation by the annotator is further expected.

Note that, instead of tracking the position in the virtual space of the VR work tool, the motion analysis unit 414 may analyze the motion of the annotator wearing the HMD such as VR goggles imaged by the imaging device 46. In this case, the camera coordinate system of the imaging device 46 is calibrated with the coordinate system of the virtual space. Furthermore, the imaging device 46 is installed at a predetermined position so as to capture the movement of the finger and the gesture of the annotator wearing the HMD. Note that the imaging device 46 may be a built-in camera mounted on a lower portion of the front surface, a left side portion, a right side portion, or the like of the VR goggles.

Furthermore, in this case, the motion analysis unit 414 detects, as a detection unit, a motion (movement of a finger, gesture, etc.) of the annotator in the real space based on the imaged image of the annotator wearing the HMD acquired by the imaging device 46. The motion analysis unit 414 further analyzes, as an analysis unit, the motion of the annotator in the virtual space based on the detected motion of the annotator in the real space. More specifically, the analysis unit maps the detected motion in the real space to a motion in the virtual space through a predetermined coordinate transformation, and tracks the motion of the annotator in the virtual space.

As another point of view, the information management apparatus according to the above embodiment can be configured as an information management method for supporting annotation work by an annotator. generating annotation information to be added to a target image. That is, the present invention can be configured as an information management method including: a management step of assigning to a worker a task of adding annotation information to an object in an image; and a setting step of setting the task so as to add the annotation information to one object included in the target image which is an image to which the annotation information is to be added by the worker, wherein in the management step, information of the task in a memory in association with the target image is stored.

Furthermore, the present invention can be configured by replacing the above information management method with a program for causing a computer to execute processing for supporting annotation work of the annotator. Furthermore, the present invention can be configured by replacing the above program with a computer-readable storage medium in which such a program is recorded.

The above embodiment can be combined as desired with one or more of the aforesaid modifications. The modifications can also be combined with one another.

According to the present invention, the efficiency of annotation work can be improved.

Above, while the present invention has been described with reference to the preferred embodiments thereof, it will be understood, by those skilled in the art, that various changes and modifications may be made thereto without departing from the scope of the appended claims.

What is claimed is:

1. An information management apparatus comprising:
a microprocessor and a memory connected to the microprocessor, wherein
the microprocessor is configured to execute task management assigning to a worker a task of adding annotation information to an object in an image,
the memory stores a target image, the target image being an image to which the annotation information is to be added by the worker, and
the microprocessor is further configured to perform:
setting the task so as to add the annotation information to one object included in the target image, and
in the task management, storing information of the task in the memory in association with the target image.

2. The information management apparatus according to claim 1, wherein
the microprocessor is configured to perform:
the setting including setting the task so that the adding of the annotation information is executed for a plurality of the target images stored in the memory, each of which includes an object of the same type.

3. The information management apparatus according to claim 1, wherein
the microprocessor is configured to perform:
the setting including setting the task so that the adding of the annotation information is executed for an object within a work window of a predetermined size superimposed and displayed on the target image.

4. The information management apparatus according to claim 3, wherein
the microprocessor is configured to perform:
the setting including further setting the task so that a region other than the work window is displayed with a lower transparency than the work window.

5. The information management apparatus according to claim 3, wherein
the microprocessor is configured to perform:
the setting including setting the task so that a plurality of windows of different sizes are applied to one target image.

6. The information management apparatus according to claim 3, wherein
the microprocessor is configured to perform:
the setting including further setting the task so that a region other than a region corresponding to an object to which the annotation information has been added in the target image is masked.

7. An information processing system comprising:
the information management apparatus according to claim 1; and
a communication terminal having a communication unit configured to communicate with the information management apparatus, wherein
the microprocessor is a first microprocessor,
the communication terminal comprises:
a display device;
a second microprocessor; and a memory connected to the second microprocessor,
the second microprocessor is configured to perform:
acquiring a series of target images stored in the memory of the information management apparatus via the communication unit;
displaying the series of target images on the display device while switching among the target images; and
detecting a user operation on one of the target images displayed on the display device, and wherein
the second microprocessor is configured to perform:
the displaying including, when a predetermined time has elapsed after displaying a target image, or when a predetermined user operation in the detecting is detected during the display of the target image, switching the display to a next target image.

8. The information processing system according to claim 7, wherein
the second microprocessor is configured to perform:
the setting including, when the switching of the display is performed according to the predetermined user operation, setting a subsequent task to be assigned to the worker so that the target image displayed before the switching of the display does not become a target for adding the annotation information by the worker.

9. The information processing system according to claim 8, wherein
each of the target images is classified into groups based on at least one of an imaging environment and a type of object in the image and stored in the memory, and
the first microprocessor is configured to perform:
the setting including setting the subsequent task to be assigned to the worker so that the target images classified into the same group as the target image before the switching of the display do not become targets for adding the annotation information by the worker.

10. The information processing system according to claim 8, wherein
the first microprocessor is further configured to perform:
determining a difficulty level of adding the annotation information to each of the target images based on the number of times the switching of the display executed for each target image, or the number of workers who performed the predetermined user operation on each target image, and
storing in the memory difficulty level information indicating the difficulty level determined for each of the target images.

11. The information processing system according to claim 10, wherein
the memory further stores work history information indicating a work history of the worker,
the first microprocessor is further configured to perform:
generating characteristic information indicating work characteristics of the worker based on the work history information stored in the memory,
the characteristic information includes information indicating a level of work skill of the worker, and
the first microprocessor is configured to perform:
the generating including storing the characteristic information in the memory in association with the work history information.

12. The information processing system according to claim 11, wherein
the first microprocessor is further configured to perform:
analyzing a quality of the annotation information assigned to the target image, and
storing quality information indicating an analysis result of the quality in the memory.

13. The information processing system according to claim 12, wherein
the first microprocessor is configured to perform:
in the task management, detecting a change in work time of the worker based on the work history information, detecting a change in work quality of the worker based on the quality information, generating condition information indicating a work condition of the worker based on the change in work time or the change in work quality and storing the condition information in the memory.

14. The information processing system according to claim 11, wherein
the first microprocessor is configured to perform:
in the task management, assigning the target image having a high difficulty level to the worker having a high work skill based on the characteristic information and the difficulty level information stored in the memory.

15. An information management apparatus comprising:
a microprocessor and a memory connected to the microprocessor, wherein
the microprocessor is configured to perform task management assigning to a worker a task of adding annotation information to an object in an image,
the memory stores a target image, the target image being an image to which the annotation information is to be added by the worker, and
the microprocessor is further configured to perform:
setting the task so as to add the annotation information to a predetermined number of objects included in the target image, and
in the task management, storing information of the task in the memory in association with the target image.
